(19) United States
(12) Patent Application Publication
(10) Pub. No.: US 2024/0151814 A1
(43) Pub. Date: May 9, 2024

(54) RADAR OBJECT RECOGNITION SYSTEM AND METHOD AND NON-TRANSITORY COMPUTER READABLE MEDIUM

(71) Applicant: National Yang Ming Chiao Tung University, Hsinchu City (TW)

(72) Inventors: Ta-Sung LEE, Hsinchu City (TW); Ming-Chun LEE, Hsinchu County (TW); Tai-Yuan HUANG, Taoyuan City (TW); Chia-Hsing YANG, Taichung City (TW)

(21) Appl. No.: 18/171,685

(22) Filed: Feb. 21, 2023

(30) Foreign Application Priority Data
Nov. 8, 2022 (TW) 111142663

(51) Int. Cl. G01S 7/41; G06T 5/00; G06V 10/32; G06V 10/764

(52) U.S. Cl. CPC G01S 7/412; G01S 7/417; G06T 5/00; G06V 10/32; G06V 10/764; G06T 2207/20081; G06T 2210/12

(57) ABSTRACT

The present disclosure provides a radar object recognition method, which includes steps as follows. The radar image generation is performed on radar data to generate a radar image; the radar image is inputted into an object recognition model, so that the object recognition model outputs a recognition result; the post-process is performed on the recognition result to eliminate recognition errors from the recognition result.

### CROSS-REFERENCE TO RELATED APPLICATION

This application claims priority to Taiwan Application Serial Number 111142663, filed Nov. 8, 2022, which is herein incorporated by reference.

### BACKGROUND

### Field of Invention

The present invention relates to recognition systems and methods, and more particularly, radar object recognition systems and methods.

### Description of Related Art

Benefiting from the vigorous development of science and technology, autonomous driving technology has attracted widespread attention in recent years. Radar has become the most commonly used sensor for autonomous vehicles because of its applicability in bad weather and low cost.

However, current technologies often directly apply existing methods to realize radar object recognition without further processing and optimization, thereby resulting in a decrease in recognition accuracy.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

According to embodiments of the present disclosure, the present disclosure provides radar object recognition systems and methods, to solve or circumvent aforesaid problems and disadvantages in the related art.

An embodiment of the present disclosure is related to a radar object recognition system, and the radar object recognition system includes a storage device and a processor. The storage device is configured to store at least one instruction. The processor is electrically connected to the storage device, and the processor is configured to execute the at least one instruction for: performing a radar image generation on a radar data to generate a radar image; inputting the radar image into an object recognition model, so that the object recognition model outputs a recognition result; performing a post-process on the recognition result to eliminate a recognition error from the recognition result.

In one embodiment of the present disclosure, the radar data is a radar data map, and the radar image generation executed by the processor includes: normalizing the radar data map to obtain a normalized radar data map; performing a target enhancement on the normalized radar data map to obtain an enhanced radar data map; performing a Cartesian coordinate conversion on the enhanced radar data map to obtain the radar image that is a two-dimensional image.

In one embodiment of the present disclosure, the object recognition model is a deep learning object recognition model, the deep learning object recognition model recognizes the radar image to obtain the recognition result, the recognition result includes a plurality of bounding boxes in the radar image, the bounding boxes have a plurality of confidence values respectively, and the confidence values represent confidence levels of the deep learning object recognition model of determining whether the bounding boxes includes an object.

In one embodiment of the present disclosure, the post-process comprises overlap elimination, and the processor executes the overlap elimination through a non-maximum suppression of different classes based on the confidence values to eliminate overlapping bounding boxes from the bounding boxes.

In one embodiment of the present disclosure, the non-maximum suppression of the different classes performed by the processor includes operations of: (A) sorting these confidence values; (B) selecting one having a maximum confidence value from the bounding boxes to be a candidate in each round; (C) when a value of an intersection between the candidate and at least one of remaining bounding boxes in the bounding boxes is greater than a predetermined threshold value, setting the confidence value of the at least one of the remaining bounding boxes to zero; (D) performing and repeating operations (B) to (C) on the remaining bounding boxes in a next round until a last bounding box serves as the candidate.

Another embodiment of the present disclosure is related to a radar object recognition method, and the radar object recognition method includes steps of: performing a radar image generation on a radar data to generate a radar image; inputting the radar image into an object recognition model, so that the object recognition model outputs a recognition result; and performing a post-process on the recognition result to eliminate a recognition error from the recognition result.

In one embodiment of the present disclosure, the radar data is a radar data map, and the step of performing the radar image generation includes: normalizing the radar data map to obtain a normalized radar data map; performing a target enhancement on the normalized radar data map to obtain an enhanced radar data map; performing a Cartesian coordinate conversion on the enhanced radar data map to obtain the radar image that is a two-dimensional image.

In one embodiment of the present disclosure, the object recognition model is a deep learning object recognition model, the deep learning object recognition model recognizes the radar image to obtain the recognition result, the recognition result includes a plurality of bounding boxes in the radar image, the bounding boxes have a plurality of confidence values respectively, and the confidence values represent confidence levels of the deep learning object recognition model of determining whether the bounding boxes includes an object.

In one embodiment of the present disclosure, the post-process comprises overlap elimination, and the overlap elimination is executed through a non-maximum suppression of different classes based on the confidence values to eliminate overlapping bounding boxes from the bounding boxes.

In one embodiment of the present disclosure, the non-maximum suppression of the different classes includes operations of: (A) sorting these confidence values; (B) selecting one having a maximum confidence value from the bounding boxes to be a candidate in each round; (C) when a value of an intersection between the candidate and at least one of remaining bounding boxes in the bounding boxes is greater than a predetermined threshold value, setting the confidence value of the at least one of the remaining bounding boxes to zero; (D) performing and repeating operations (B) to (C) on the remaining bounding boxes in a next round until a last bounding box serves as the candidate.

Yet another embodiment of the present disclosure is related to a non-transitory computer readable medium to store a plurality of instructions for commanding a computer to execute a radar object recognition method, and the radar object recognition method includes steps of: performing a radar image generation on a radar data to generate a radar image; inputting the radar image into an object recognition model, so that the object recognition model outputs a recognition result; and performing a post-process on the recognition result to eliminate a recognition error from the recognition result.

In view of the above, with the radar object recognition system and radar object recognition method of the present disclosure, the radar image generated by the radar image generation is conducive to the object recognition model for recognition, and the post-process (e.g., overlap elimination) can effectively eliminate the recognition error (e.g., overlapping error) in the recognition result, thereby improving the recognition accuracy.

Many of the attendant features will be more readily appreciated, as the same becomes better understood by reference to the following detailed description considered in connection with the accompanying drawings.

### BRIEF DESCRIPTION OF THE DRAWINGS

The invention can be more fully understood by reading the following detailed description of the embodiment, with reference made to the accompanying drawings as follows:

FIG. 1 is a block diagram of a radar object recognition system according to some embodiments of the present disclosure;

FIG. 2 is a flow chart of a radar object recognition method according to some embodiments of the present disclosure; and

FIG. 3 is a flow chart of a radar image generation according to some embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

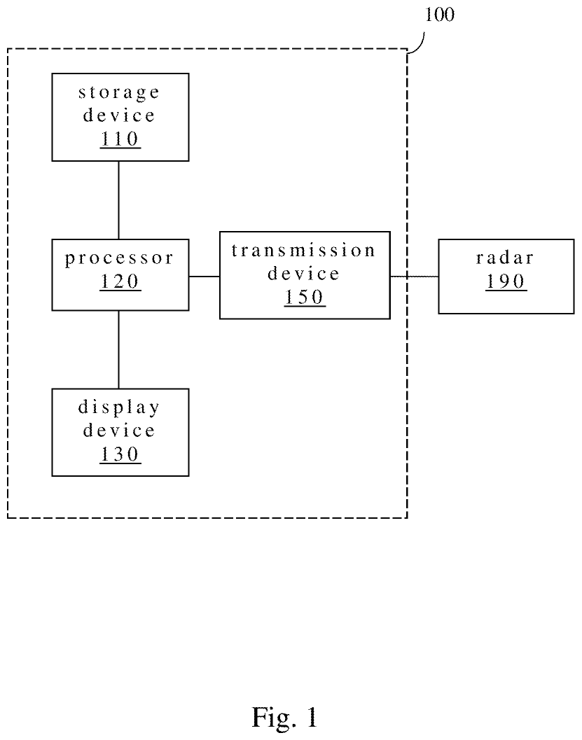

Referring to FIG. 1, in one aspect, the present disclosure is directed to a radar object recognition system 100. This system may be easily integrated into a computer server and may be applicable or readily adaptable to all technologies. Accordingly, the radar object recognition system 100 has advantages. Herewith the radar object recognition system 100 is described below with FIG. 1.

The subject disclosure provides the radar object recognition system 100 in accordance with the subject technology. Various aspects of the present technology are described with reference to the drawings. In the following description, for purposes of explanation, numerous specific details are set forth in order to provide a thorough understanding of one or more aspects. It can be evident, however, that the present technology can be practiced without these specific details. In other instances, well-known structures and devices are shown in block diagram form in order to facilitate describing these aspects. The word “exemplary” is used herein to mean “serving as an example, instance, or illustration.” Any embodiment described herein as “exemplary” is not necessarily to be construed as preferred or advantageous over other embodiments.

FIG. 1 is a block diagram of the radar object recognition system 100 according to some embodiments of the present disclosure. As shown in FIG. 1, the radar object recognition system 100 can includes a storage device 110, a processor 120, a display device 130 and a transmission device 150. For example, the storage device 110 can be a hard disk, flash storage device or another storage circuit, the processor 120 can be a central processor, a controller or another circuit, the display device 130 can be a built-in display device or an external screen, and the transmission device 150 can be a transmission line, a communication device or another transmission circuit.

In structure, the radar object recognition system 100 is electrically connected to the radar 190, the storage device 110 is electrically connected to the processor 120, the processor 120 is electrically connected to the display device 130, and the processor 120 is electrically connected to the transmission device 150. In practice, for example, radar 190 may include one or more radars to be assigned to one or more vehicles or roadside units respectively. It should be noted that when an element is referred to as being “connected” or “ coupled” to another element, it can be directly connected or coupled to the other element or intervening elements may be present. In contrast, when an element is referred to as being “directly connected” or “directly coupled” to another element, there are no intervening elements present. For example, the storage device 110 may be a built-in storage device that is directly connected to the processor 120, or the storage device 110 may be an external storage device that is indirectly connected to the processor 120 through wires.

In use, the storage device 110 is configured to store at least one instruction. The processor 120 is configured to execute the at least one instruction for: performing a radar image generation on a radar data to generate a radar image; inputting the radar image into an object recognition model, so that the object recognition model outputs a recognition result; performing a post-process on the recognition result to eliminate a recognition error from the recognition result. In this way, the radar object recognition system 100 can obtain the position, shape, category and size of the object in the radar image. Compared with only directly applying the object recognition model to a radar system, the radar object recognition system 100 can improve the recognition accuracy and provide users with more accurate recognition results.

Regarding the above radar data, in practice, for example, the radar data can be the raw data detected by the radar 190, the processed information of the aforementioned raw data or any information output by the radar 190. The radar data can be a radar data map or the like.

In one embodiment of the present disclosure, the above-mentioned radar data is the radar data map, such as a radar range-angle map (RA map), a radar range-Doppler map (RD map), a radar range-range Map (RR map), but not limited thereto. The radar image generation executed by the processor 120 includes: normalizing the radar data map to obtain a normalized radar data map; performing a target enhancement on the normalized radar data map to obtain an enhanced radar data map; performing a Cartesian coordinate conversion on the enhanced radar data map to obtain the radar image that is a two-dimensional image (e.g., a two-dimensional three-primary-color image). In practice, compared to the radar data map, the two-dimensional radar image is more suitable for the object recognition model for object recognition. In this way, the radar object recognition system 100 improves the accuracy of the radar object recognition.

Regarding the above-mentioned object recognition model, in practice, for example, the object recognition model can be a machine learning model, an artificial intelligence model, a deep learning model, a neural network model, or another model constructed by an algorithm, a mathematical formula or an evaluation method that can equivalently accomplish the same work goal.

In one embodiment of the present disclosure, the object recognition model is a deep learning object recognition model (e.g., a YOLO object detection model), and the deep learning object recognition model recognizes the radar image to obtain the recognition result, the recognition result includes a plurality of bounding boxes in the radar image, the bounding boxes have a plurality of confidence values respectively, and the confidence values represent confidence levels of the deep learning object recognition model of determining whether the bounding boxes includes an object. For example, the higher confidence value represents the higher the confidence level of the object contained in the corresponding bounding box.

Regarding the above-mentioned post-process, in one embodiment of the present disclosure, the post-process can include overlap elimination, and the processor 120 executes the overlap elimination through a non-maximum suppression of different classes (NMSDC) based on the confidence values to eliminate overlapping bounding boxes from the bounding boxes. In this way, the radar object recognition system 100 improves the accuracy of the radar object recognition.

Regarding the above-mentioned non-maximum suppression of the different classes, in one embodiment of the present disclosure, the non-maximum suppression of the different classes performed by the processor 120 includes operations of: (A) sorting these confidence values; (B) selecting one having a maximum confidence value from the bounding boxes to be a candidate in each round; (C) when a value of an intersection between the candidate and at least one of remaining bounding boxes in the bounding boxes is greater than a predetermined threshold value, setting the confidence value of the at least one of the remaining bounding boxes to zero; (D) performing and repeating operations (B) to (C) on the remaining bounding boxes in a next round until a last bounding box serves as the candidate. In this way, the non-maximum suppression of the different classes executed by processor 120 can eliminate overlapping bounding boxes, thereby retaining the bounding box corresponding to the target in the radar image, and providing the user with more accurate recognition result. For example, the display device 130 can display the recognition result.

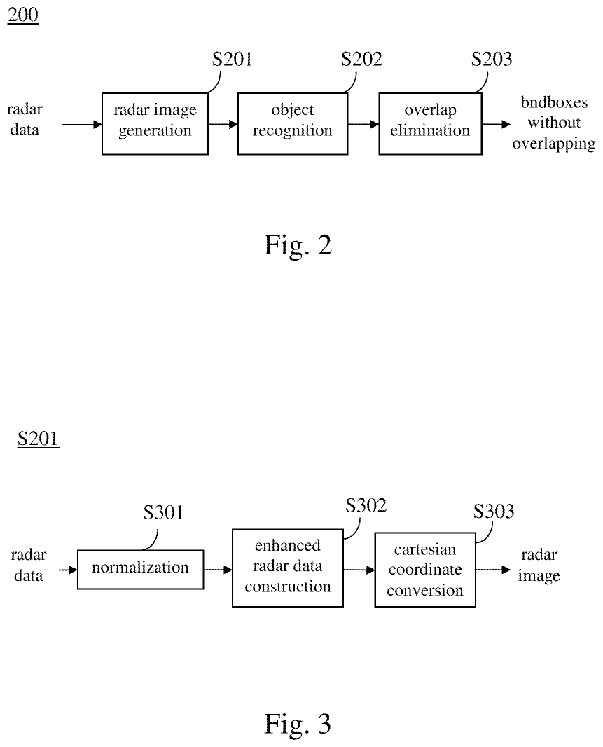

For a more complete understanding of a radar object recognition method performed by the radar object recognition system 100, referring FIG. 1 and FIG. 2, FIG. 2 is a flow chart of the radar object recognition method 200 according to an embodiment of the present disclosure. As shown in FIG. 2, the radar object recognition method 200 includes steps S201, S202 and S203. However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently.

The radar object recognition method 200 may take the form of a computer program product on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives.

In step S201, the radar image generation is performed on the radar data to generate the radar image. In step S202, the radar image is inputted into the object recognition model, so that the object recognition model outputs the recognition result. In step S203, the post-process is performed on the recognition result to eliminate the recognition error (e.g., overlap error) from the recognition result (e.g., overlap elimination).

In one embodiment of the present disclosure, the object recognition model in step S202 is a deep learning object recognition model, and the radar image is beneficial to the deep learning object recognition model for the object recognition. The deep learning object recognition model recognizes the radar image to obtain the recognition result, the recognition result includes a plurality of bounding boxes in the radar image, the bounding boxes have a plurality of confidence values respectively, and the confidence values represent confidence levels of the deep learning object recognition model of determining whether the bounding boxes includes the object.

In practice, for example, the deep learning object recognition model may be a YOLO object detection model, which is a one-stage neural network model for the object recognition. Traditionally, two steps are required to complete the object recognition, namely Detection and Classification, in which the former is to judge the position of the object; the latter is to classify the object. Compared with the two-stage method, YOLO detects and classifies objects at the same time, thereby improving the recognition speed. Specifically, YOLO firstly divides the input image into a plurality of grid units (Grid), and then predicts multiple bounding boxes for grid units respectively, and the corresponding confidence values (Confidence) of the bounding boxes represents the confidence levels of YOLO of determining whether the bounding boxes include the object. For each bounding box, there are the following prediction results: the center coordinates of the bounding box; the length and width of the bounding box; the confidence value and the category of the bounding box. In this way, the preliminary recognition result can be obtained through YOLO.

In one embodiment of the present disclosure, the post-process of step S203 includes overlap elimination, and the overlap elimination is executed through a non-maximum suppression of different classes based on the confidence values to eliminate overlapping bounding boxes from the bounding boxes. In this way, the radar object recognition method 200 improves the accuracy of the radar object recognition.

In one embodiment of the present disclosure, the non-maximum suppression of the different classes of step S203 includes operations of: (A) sorting these confidence values; (B) selecting one having a maximum confidence value from the bounding boxes to be a candidate in each round; (C) when a value of an intersection between the candidate and at least one of remaining bounding boxes in the bounding boxes is greater than a predetermined threshold value, setting the confidence value of the at least one of the remaining bounding boxes to zero; (D) performing and repeating operations (B) to (C) on the remaining bounding boxes in a next round until a last bounding box serves as the candidate. In this way, the non-maximum suppression of different classes performed by step S203 can eliminate the overlapping bounding boxes, thereby retaining the bounding box corresponding to the object in the radar image.

In practice, for example, overlap elimination mainly removes overlapping bounding boxes through the non-maximum suppression of the different classes. First, all detected bounding boxes are sorted according to the confidence values, the bounding box having the maximum confidence value is a candidate in each round, and then the value of the intersection between the candidate and each of other bounding boxes is calculated sequentially. When the value of the intersection is greater than a predetermined threshold value, the confidence value of the corresponding of the other bounding boxes is set to zero. After the calculation is completed, all remaining bounding boxes enter the next round until the last bounding box serves as a candidate.

For a more complete understanding of the radar image generation of step S201, referring FIG. 1, FIG. 2 and FIG. 3, FIG. 3 is a flow chart of the radar image generation according to an embodiment of the present disclosure. As shown in FIG. 3, step S201 includes sub-steps S301, S302 and S303. However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently.

In one embodiment of the present disclosure, the above-mentioned radar data is the radar data map, such as a radar range-angle map (RA map), a radar range-Doppler map (RD map), a radar range-range Map (RR map), but not limited thereto.

In sub-step S301, the radar data map is normalized to obtain a normalized radar data map. In sub-step S302, a target enhancement is performed on the normalized radar data map to obtain an enhanced radar data map. In sub-step S303, a Cartesian coordinate conversion is performed on the enhanced radar data map to obtain the radar image that is a two-dimensional image (e.g., a two-dimensional three-primary-color image). In practice, compared to the radar data map, the two-dimensional radar image is more suitable for the object recognition model for object recognition. In this way, the radar object recognition method 200 improves the accuracy of the radar object recognition.

In practice, taking the example of the radar range-angle map (RA map), the radar image generation mainly generates the radar image through the target enhancement technology (THT). Firstly, after obtaining the raw RA map, the radar image generation technology enhances the feature information in the raw RA map. The normalization is performed on all collected RA maps to obtain normalized RA maps M^{NRA}. By setting the signal strength to limit and enhance the normalized RA maps M^{NRA} to obtain the enhanced RA maps M^{ERA}. Finally, the enhanced RA maps are converted into range-range maps, so as to output the range-range maps as images.

Specifically, since differences in the signal strengths of respective range-angle bins (RA bin) in the radar RA map vary greatly, sub-step S301 firstly unifies all signal strengths through the normalization, in which the maximum and minimum signal strengths are defined as shown in equation (1):

$${S}_{max} = {max}_{n , q , {n}_{f}} ( {( {M}^{RA} )}_{n , q} ( {n}_{f} ) ) , {S}_{min} = {min}_{n , q , {n}_{f}} ( {( {M}^{RA} )}_{n , q} ( {n}_{f} ) ) , \qquad ( 1 )$$

$$n = 1 , ... , N , q = 1 , ... , Q , {n}_{f} = 1 , ... , {N}_{f}$$

Then, above two values are processed through the normalization as shown in equation (2):

$${( {M}^{NRA} )}_{n , q} ( {n}_{f} ) = \frac{{( {M}^{RA} )}_{n , q} ( {n}_{f} ) - {S}_{min}}{{S}_{max} - {S}_{min}} , \qquad ( 2 )$$

$$n = 1 , ... , N , q = 1 , ... , Q , {n}_{f} = 1 , ... , {N}_{f}$$

Furthermore, the median value of all signal strengths of all RA bins on the normalized RA maps M^{NRA} as the minimum value Sₘᵢₙ of signal strength, and the maximum value Sₘₐₓ of signal strength is set to 1, as shown in equation (3):

S_{UB}=1, S_{LB}=medium_{n,q,n}_{_{f}}((M^{NRA})_{n,q}(N_{f})),

n=1, . . . , N, q=1, . . . , Q, n_{f}=1, . . . , N_{f} (3)

Then sub-step S302 carries out secondary processing to all normalized RA maps M^{NRA}, to generates enhanced RA maps M^{ERA}, as shown in equation (4):

$${M}^{ERA} ( {n}_{f} ) = \{ \begin{matrix}{( {M}^{NRA} ( {n}_{f} ) )}^{{x}_{e}} , & ( {M}^{NRA} ) ( {n}_{f} ) \geq {S}_{LB} \\ 0 , & ( {M}^{NRA} ) ( {n}_{f} ) < {S}_{LB}\end{matrix} \qquad ( 4 )$$

n_{f} is the total number of collected radar images, and xₑ is a controllable marking parameter. Finally, sub-step S303 converts the enhanced RA maps into two-dimensional RGB images through Cartesian coordinate conversion, and the output image is the above-mentioned radar image.

In view of the above, with the radar object recognition system 100 and radar object recognition method 200 of the present disclosure, the radar image generated by the radar image generation is conducive to the object recognition model for recognition, and the post-process (e.g., overlap elimination) can effectively eliminate the recognition error (e.g., overlapping error) in the recognition result, thereby improving the recognition accuracy.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A radar object recognition system, comprising:
a storage device configured to store at least one instruction; and
a processor electrically connected to the storage device, and the processor configured to execute the at least one instruction for:
performing a radar image generation on a radar data to generate a radar image;
inputting the radar image into an object recognition model, so that the object recognition model outputs a recognition result; and
performing a post-process on the recognition result to eliminate a recognition error from the recognition result.

2. The radar object recognition system of claim 1, wherein the radar data is a radar data map, and the radar image generation executed by the processor comprises:
normalizing the radar data map to obtain a normalized radar data map;
performing a target enhancement on the normalized radar data map to obtain an enhanced radar data map; and
performing a Cartesian coordinate conversion on the enhanced radar data map to obtain the radar image that is a two-dimensional image.

3. The radar object recognition system of claim 1, wherein the object recognition model is a deep learning object recognition model, the deep learning object recognition model recognizes the radar image to obtain the recognition result, the recognition result comprises a plurality of bounding boxes in the radar image, the bounding boxes have a plurality of confidence values respectively, and the confidence values represent confidence levels of the deep learning object recognition model of determining whether the bounding boxes comprises an object.

4. The radar object recognition system of claim 3, wherein the post-process comprises overlap elimination, and the processor executes the overlap elimination through a non-maximum suppression of different classes based on the confidence values to eliminate overlapping bounding boxes from the bounding boxes.

5. The radar object recognition system of claim 4, wherein the non-maximum suppression of the different classes performed by the processor comprises operations of:
(A) sorting these confidence values;
(B) selecting one having a maximum confidence value from the bounding boxes to be a candidate in each round;
(C) when a value of an intersection between the candidate and at least one of remaining bounding boxes in the bounding boxes is greater than a predetermined threshold value, setting the confidence value of the at least one of the remaining bounding boxes to zero; and
(D) performing and repeating operations (B) to (C) on the remaining bounding boxes in a next round until a last bounding box serves as the candidate.

6. A radar object recognition method, comprising steps of:
performing a radar image generation on a radar data to generate a radar image;
inputting the radar image into an object recognition model, so that the object recognition model outputs a recognition result; and
performing a post-process on the recognition result to eliminate a recognition error from the recognition result.

7. The radar object recognition method of claim 6, wherein the radar data is a radar data map, and the step of performing the radar image generation comprises:
normalizing the radar data map to obtain a normalized radar data map;
performing a target enhancement on the normalized radar data map to obtain an enhanced radar data map; and
performing a Cartesian coordinate conversion on the enhanced radar data map to obtain the radar image that is a two-dimensional image.

8. The radar object recognition method of claim 6, wherein the object recognition model is a deep learning object recognition model, the deep learning object recognition model recognizes the radar image to obtain the recognition result, the recognition result comprises a plurality of bounding boxes in the radar image, the bounding boxes have a plurality of confidence values respectively, and the confidence values represent confidence levels of the deep learning object recognition model of determining whether the bounding boxes comprises an object.

9. The radar object recognition method of claim 8, wherein the post-process comprises overlap elimination, and the overlap elimination is executed through a non-maximum suppression of different classes based on the confidence values to eliminate overlapping bounding boxes from the bounding boxes.

10. The radar object recognition method of claim 9, wherein the non-maximum suppression of the different classes comprises operations of:
(A) sorting these confidence values;
(B) selecting one having a maximum confidence value from the bounding boxes to be a candidate in each round;
(C) when a value of an intersection between the candidate and at least one of remaining bounding boxes in the bounding boxes is greater than a predetermined threshold value, setting the confidence value of the at least one of the remaining bounding boxes to zero; and
(D) performing and repeating operations (B) to (C) on the remaining bounding boxes in a next round until a last bounding box serves as the candidate.

11. A non-transitory computer readable medium to store a plurality of instructions for commanding a computer to execute a radar object recognition method, and the radar object recognition method comprising:
performing a radar image generation on a radar data to generate a radar image;
inputting the radar image into an object recognition model, so that the object recognition model outputs a recognition result; and
performing a post-process on the recognition result to eliminate a recognition error from the recognition result.

12. The non-transitory computer readable medium of claim 11, wherein the radar data is a radar data map, and the step of performing the radar image generation comprises:
normalizing the radar data map to obtain a normalized radar data map;
performing a target enhancement on the normalized radar data map to obtain an enhanced radar data map; and
performing a Cartesian coordinate conversion on the enhanced radar data map to obtain the radar image that is a two-dimensional image.

13. The non-transitory computer readable medium of claim 11, wherein the object recognition model is a deep learning object recognition model, and the deep learning object recognition model recognizes the radar image to obtain the recognition result, the recognition result comprises a plurality of bounding boxes in the radar image, the bounding boxes have a plurality of confidence values respectively, and the confidence values represent confidence levels of the deep learning object recognition model of determining whether the bounding boxes comprises an object.

14. The non-transitory computer readable medium of claim 13, wherein the post-process comprises overlap elimination, and the overlap elimination is executed through a non-maximum suppression of different classes based on the confidence values to eliminate overlapping bounding boxes from the bounding boxes.

15. The non-transitory computer readable medium of claim 14, wherein the non-maximum suppression of the different classes comprises operations of:
(A) sorting these confidence values;
(B) selecting one having a maximum confidence value from the bounding boxes to be a candidate in each round;
(C) when a value of an intersection between the candidate and at least one of remaining bounding boxes in the bounding boxes is greater than a predetermined threshold value, setting the confidence value of the at least one of the remaining bounding boxes to zero; and
(D) performing and repeating operations (B) to (C) on the remaining bounding boxes in a next round until a last bounding box serves as the candidate.
